(19) United States
(12) Patent Application Publication
(10) Pub. No.: US 2001/0016801 A1
(43) Pub. Date: Aug. 23, 2001

(54) Monitoring and control system for mobile devices

(76) Inventors: Andreas Kruschinski, Dusseldorf (DE); Urban Franzke, Monheim (DE); Arno van de Loo, Erkrath (DE); Johannes Reiss, Hilden (DE); Horst Weyl, Meerbusch (DE)

Correspondence Address: Thomas C. Pontani, Esq., Cohen, Pontani, Lieberman & Pavane, Suite 1210, 551 Fifth Avenue, New York, NY, 10176, US

(21) Appl. No.: 09/775,155

(22) Filed: Feb. 1, 2001

(30) Foreign Application Priority Data
Feb. 3, 2000 (DE) 100 04 861.7

(51) Int. Cl. G05D 1/00

(52) U.S. Cl. 702/188; 701/2

(57) ABSTRACT

The invention relates to a monitoring and control system for mobile lifting and transport devices such as cranes, building machines, and transport vehicles, in which status data is obtained by monitoring selected device components and conveyed to at least one control console. Data and/or control commands are transmitted from the control console to the monitoring and control system. The system is operated with an open expandable architecture of exchangeable standard PC components and uses a real-time operating system for hard real-time computing and with a user program which conforms to IEC 1131-3.

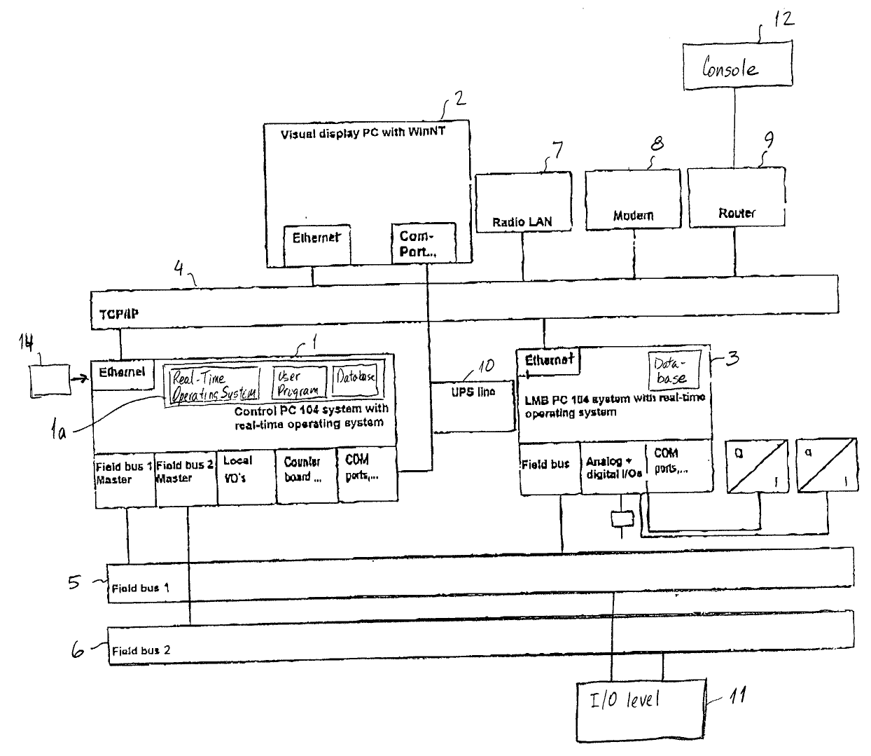

### BACKGROUND OF THE INVENTION

1. Field of the Invention

The invention relates to a monitoring and control system for a mobile lifting and transport device such as a crane, a building machine, and a transport vehicle in which status data obtained by monitoring selected device components of the lifting and transport device are conveyed to at least one control console and data and/or control commands are transmitted from the control console to the monitoring and control system, wherein the data may be transmitted via remote data transmission.

2. Description of the Related Art

In general, monitoring and control systems for controlling mobile lifting and transport devices such as mobile cranes, mobile harbor cranes, excavators, rail cranes, container transporters, and building machines use stored-program controls (SPCs) or soft SPCs in Windows-based controls systems.

The prior art monitoring and control system solutions use hardware that is specific to the manufacturer of the mobile lifting and transport device. Accordingly, when components of the system are changed with components of a different manufacturer, the hardware must be adapted to the new system. In these known systems, the software (i.e., the operating system and the SPC programming tool) is manufacturer-related so that the software must also be adapted to changes in the mobile lifting and transport device. Communication between the monitoring and control system with higher-level PC systems requires manufacturer-related drivers. However, the user software for the monitoring and control system is not compatible with the other manufacturers. Finally, the bus systems which are used to connect the monitoring and control system to the devices on the mobile lifting and transport device are also manufacturer-related and may not be combined with other bus systems.

Furthermore, the known SPC systems require a large space, have a small temperature range, a low ingress protection class and poor EMC (electromagnetic compatibility) characteristics. The soft SPC is not capable of implementing real-time characteristics without additional modifications of the hardware and/or software.

### SUMMARY OF THE INVENTION

The object of the present invention is to provide a monitoring and control system for industrial mobile lifting and transport devices using manufacturer-independent hardware and software components and implementing real-time processing characteristics.

The object of the present invention is achieved by a system operated with an open expandable architecture of exchangeable standard PC components using a real-time operating system for hard real-time computing and with a user program which is manufacturer-independent due to the use of an SPC programming tool according to the International Electrotechnical Commission (IEC) standard for programmable controllers IEC 1131-3.

By using standard personal computer (PC) components, the system does not require further fundamental adaptations when parts of the system are changed because the components are largely compatible. Since the components are largely compatible, no manufacturer-related drivers are needed for communication with higher-level PC systems. With the appropriate programming tool, the real-time operating system enables the implementation of hard real-time computing.

The system according to the present invention may be included directly in existing networks. Furthermore, standard PC components may be inserted into the system for remote maintenance/diagnostics via a radio LAN system or modem.

The present invention may be used with all field bus systems currently sold on the market. Indeed, more than one type of bus system may be simultaneously used.

According to a further feature of the invention, appropriate routers may be arranged to provide data security and for logging the control console into the various computers connected in the system.

For the purpose of maintaining large quantities of data, databases are installed on a computer including the real-time operating system and the user program or on other computers.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawing is a block diagram showing a monitoring and control system according to an embodiment of the present invention.

### DETAILED DESCRIPTION OF THE PRESENTLY PREFERRED EMBODIMENTS

The block diagram shows a monitoring control system for a mobile lifting and transport device such as a crane including an industrial personal computer (PC) 1 which may, for example, be a PC/104 type PC. The PC 1 comprises a memory 1a with a real-time operating system such as, for example, QNX and VxWorks and a user program according to IEC 1131.3 for computing the control tasks in the control/computer design according to the present invention. This industrial PC 1 communicates with the decentralized I/O level 11 via the two bus systems 5 and 6. The decentralized I/O level 11 provides status data by monitoring selected device components of the mobile lifting and transport device. Furthermore commands are transmitted to the mobile lifting and transport device via the decentralized I/O level 11. In addition, the industrial PC 1 communicates via another bus system 4 via Transmission Control Protocol/Internet Protocol (TCP/IP) with at least one other industrial PC 2 for operator control and visual display. Further computers which may also comprise industrial PCs such as PC 3 are connectable to the bus system 4 for performing detailed tasks such as load moment limiter or controller applications. The memory 1a of PC1 may comprise a database for storing data such as historical data. Alternatively, the data could be stored in another PC of the system such as PC 3.

The block diagram additionally shows a local area radio network interface 7 and a modem interface 8 which is connectable to, for example, an ISDN network for teleservice (including the data transmission for changing parameters or for updating the software). In other words, the PC 1 is connectable to the internet or other network via the modem interface 8 for downloading updates for system parameters and/or programs, and/or other data from a server operated by, for example, the provider of the operating system or the provider of the user program. Of course, the modem interface 8 may alternatively be connected to phone lines, cable lines, or any service line connectable to the internet. The block diagram also includes a router interface 9 to a router operable for allowing a control console 12 to log in to the various PCs 1, 2, 3. A maintenance/diagnostics module 14 may be connected in the PC 1 for performing remote maintenance/diagnostics via the LAN interface 7 or the modem interface 8.

PC 1 also includes a UPS system 10 via its local I/Os ports, i.e., COM ports, in conjunction with a set of batteries. The PC 1 is connected to the PC 2 via the COM interface. PC 1 signals to PC 2 to run the shut-down. As soon as PC 2 has given the acknowledgement to PC 1, PC 1 switches off the system.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A monitoring and control system connectable to a control console for controlling a mobile lifting and transport device, comprising:
exchangeable personal computer components having an open expandable architecture and including at least one personal computer using a real-time operating system for hard real-time computing and manufacture-independent user program which conforms with the IEC 1131-3 standard for programmable controllers; and
a decentralized I/O level operatively connectable for monitoring status data of selected device components of the mobile lifting and transport device, said decentralized I/O level being connected to said at least one personal computer, and said exchangeable personal computer components being connectable to the control console for transmitting the status data to the control console and for receiving one of the data and control commands from the control console.

2. The monitoring and control system of claim 1, wherein said exchangeable personal computer components are connectable to existing networks.

3. The monitoring and control system of claim 1, wherein exchangable personal computer components include a maintenance/diagnostics component operatively arranged for performing remote maintenance/diagnostics via one of a radio LAN interface and a modem interface.

4. The monitoring and control system of claim 1, wherein said exchangeable personal computer components further comprise at least one conventional field bus system for connecting said at least one computer to said decentralized I/O level.

5. The monitoring and control system of claim 1, further comprising databases installed in said at least one personal computer.

6. The monitoring and control system of claim 1, wherein said real-time operating system includes one of a QNX operating system and VxWorks operating system.
